(19) United States
(12) Patent Application Publication
(10) Pub. No.: US 2007/0007939 A1
(43) Pub. Date: Jan. 11, 2007

(54) Low voltage electrical vehicle propulsion system using double layer capacitors

(76) Inventors: John M. Miller, Cedar, MI (US); Richard Smith, San Diego, CA (US)

Correspondence Address: HENSLEY KIM & EDGINGTON, LLC, 1660 LINCOLN STREET, SUITE 3050, DENVER, CO, 80264-3103, US

(21) Appl. No.: 11/436,964

(22) Filed: May 16, 2006

Related U.S. Application Data
(60) Provisional application No. 60/681,314, filed on May 16, 2005.

(51) Int. Cl. G05F 5/00

(52) U.S. Cl. 323/299

(57) ABSTRACT

A hybrid vehicle propulsion system with a double-layer capacitor is provided. A low voltage double-layer capacitor energy storage system provides power to a hybrid vehicle propulsion system. A boost converter boosts the voltage of the double-layer capacitor system to a higher operating voltage to power at least one motor/generator of the propulsion system.

### CROSS-REFERENCE TO RELATED APPLICATIONS

This application claims the benefit of U.S. provisional application No. 60/681,314 entitled “Low voltage electrical vehicle propulsion system using double-layer capacitors,” filed 16 May 2005, which is hereby incorporated by reference as though fully set forth herein.

### BACKGROUND

a. Field of the Invention

The instant invention relates to electrical propulsion systems. In particular, the instant invention relates to low voltage electrical vehicle propulsion systems using double-layer capacitors.

b. Background

Hybrid motor vehicles in which two sources of vehicular power are used for propulsion are well known. Various schemes exist for transferring the power from an internal combustion engine (ICE) and/or battery electrical energy storage to wheels of a vehicle, including systems known to those skilled in the art as parallel, series, and power split. For example, a Toyota Prius brand of vehicle utilizes both an internal combustion engine and batteries to provide power to an electronic continuously variable transmission (e-CVT) that is used to propel the vehicle.

In one configuration, the batteries are coupled to the wheels of a vehicle via an electric motor/generator. The batteries can be used to power the electric motor/generator to drive the wheels. When the batteries are not being used to power the electric motor/generator and drive the wheels, the electric motor/generator can be used to recapture kinetic energy (e.g., from braking), convert the kinetic energy to electrical energy, and store the electrical energy in the batteries.

Typical batteries used in a hybrid vehicle need to be on the order of 144 to 300 volts, or even higher. Batteries are limited by the amount of current they can safely and reliably deliver. Power delivered is determined by a product of a current and voltage being delivered by the batteries. Because of the high power needed to drive the wheels and the limited current provided by batteries, an increase in voltage is required to increase the power delivered from the batteries.

High voltage levels of the batteries can cause problematic and even dangerous conditions in an electrical system of a hybrid vehicle. The voltage levels may present, for example, risk of damage to electrical components or harm to operators or passengers. Many organizations and agencies have an interest in testing and qualification of electrical circuits for vehicular applications, for example, Underwriter Laboratories (UL) and the Society of Automotive Engineers (SAE). Such organizations have identified that different voltage levels can constitute different safety hazards. Two such voltage levels are 150 and 300 volts. The higher voltage levels require more stringent testing and qualification.

### SUMMARY

It is desirable to be able to provide a lower voltage power supply for a hybrid vehicle propulsion system, while still providing a higher voltage to power the motor/generators of the propulsion system in order to provide a higher efficiency of the system. A hybrid vehicle propulsion system with a double-layer capacitor is provided.

Double-layer capacitors exhibit lower maintenance, longer life, and lower temperature characteristics than can be provided by batteries. Double-layer capacitors are also capable of higher efficiency and power than batteries.

Hybrid vehicles using lower voltage double-layer capacitors may be easier to qualify at various governmental and independent organizations that may be involved in their safety testing. Double-layer capacitors can provide sufficient power even when the capacitors themselves provide no more than about sixty volts. The sixty volt threshold has recently been designated as yet another plateau where qualification of systems is even less stringent. For example, SAE has established an Electrical Distribution Systems Committee for the establishment of an SAE Standard for low tension primary cable intended for use at a nominal voltage of sixty volts DC (twenty-five volts AC) or less in surface vehicle electrical systems. The tests are intended to qualify cables for normal applications with limited exposure to fluids and physical abuse. Police, fire, and ambulance agencies are also concerned with voltage levels that their members may be exposed to from energy storage modules, such as batteries, during typical emergency situations and, thus, would prefer to be exposed to as low of voltage levels as possible when such emergency situations involve a hybrid vehicle. A range of voltages below sixty volts DC has been designated by some agencies as Super Extra Low Voltage (SELV). A hybrid vehicle with an SELV rating thus provides many advantages.

As such, one hybrid vehicle application that is improved by the availability of a low voltage double-layer capacitor energy storage system is a compound e-CVT system. The availability of double-layer capacitors can provide increased current and thus sufficient power to enable a compound split-type hybrid vehicle to be used with a double-layer capacitor module system at about sixty volts DC or below. In one compound split-type e-CVT unbuffered electrical storage system configuration that utilizes double-layer capacitors at about sixty volts DC or below, a module of ultracapacitors can be coupled to one or more motor/generator via an electrical bus, with the module being rated at about sixty volts or less.

In one configuration, for example, a DC-DC boost-buck converter can be used to raise the voltage of a double-layer capacitor module via a floating bus such that a hybrid vehicle can be used with the module without a need for a change in the underlying design of the motor/generator design of the hybrid vehicle. Thus, the motor/generator can still operate at the higher efficiency of the higher voltage levels without requiring the higher voltage levels being stored in the double-layer capacitor module system. The DC-DC converter may be used, for example, to boost the voltage of a double-layer capacitor module from about sixty volts DC to about 144 or more volts DC. When energy is required to drive the hybrid vehicle in boost (hybrid mode), it is released from the double-layer capacitor module and boosted to an operating voltage by the DC-DC converter. When recuperation of braking energy is available, it is stored back in the double-layer capacitor module. Because electrical sources of power can be provided at a lower voltage than previously possible, a hybrid vehicle can be treated as being intrinsically safer and more reliable than prior art hybrid vehicles, for example, because no more than about sixty volts DC is ever present at the output of a double-layer capacitor module.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an exemplary single mode electronic continuously variable transmission system for a hybrid vehicle.

FIG. 2 shows an exemplary compound split electronic continuously variable transmission system for a hybrid vehicle.

FIG. 3 shows an exemplary configuration of a low voltage double-layer capacitor powered power train system for a hybrid vehicle.

FIG. 4 shows another exemplary configuration of a power train system for a hybrid vehicle.

### DETAILED DESCRIPTION

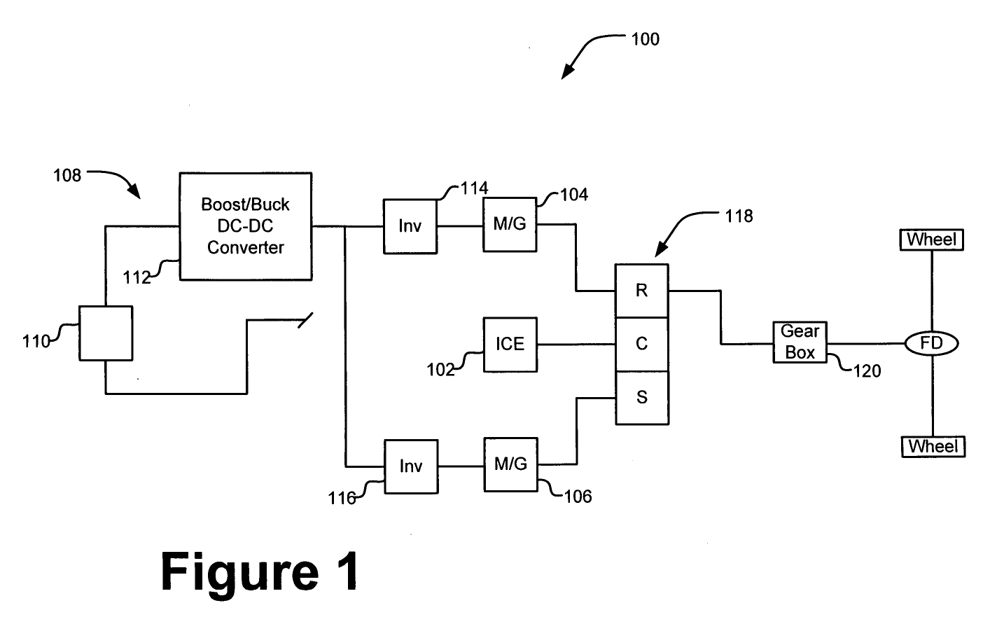

FIG. 1 shows an exemplary single mode electronic continuously variable transmission system 100 for a hybrid vehicle. In this implementation, the total propulsion is the sum of an internal combustion engine 102 and a pair of motor/generators 104, 106 driven by a double-layer capacitor power supply 108. The power supply 108 comprises a relatively low voltage double-layer capacitor module 110 (i.e., less than about 140 volts DC), a boost/buck DC-DC converter 112, and a pair of inverters 114, 116. Double-layer capacitors are also commonly referred to as ultracapacitors or supercapacitors. In one implementation, for example, the double-layer capacitor module 110 is rated for no more than about 60 volts DC, no more than about 100 volts DC, or no more than about 140 volts DC.

The boost/buck DC-DC converter 112 boosts the voltage level of the double-layer capacitor module 110 to provide a relatively high voltage (i.e., above at least about 144 volts DC) and provides the boosted voltage level to the pair of inverters 114, 116. The pair of inverters 114, 116 convert the DC voltage level provided from the boost/buck DC-DC converter 112 to AC voltage and provide the AC voltage to the pair of motor/generators 104, 106.

The first motor/generator 104 is connected to a ring gear R of a planetary gear set 118, and the second motor/generator 106 is connected to a sun gear S of the planetary gear set 118. The internal combustion engine 102 is also connected to the planetary gear set 118 at planetary carrier gear C. The planetary gear set 118 acts as a speed summing junction that functions as a continuously variable transmission. The ring gear R of the planetary gear set 118 is also connected to a gear box 120, which is in turn connected to a final drive differential gear that drives the wheels of the hybrid vehicle.

During part of the operation of the hybrid vehicle, the motor/generators 104, 106 provide power to the planetary gear set that can be used instead of or in addition to the internal combustion engine 102 to propel the hybrid vehicle. During other portions of the operation of the hybrid vehicle, one or both of the electric motor/generators 104, 106 can be used to recapture kinetic energy (e.g., from braking), convert the kinetic energy to electrical energy, and store the electrical energy in the double-layer capacitor module 110 via the inverters 114, 116 and the boost/buck DC-DC power converter 112 (now operating as a buck converter to step down the voltage).

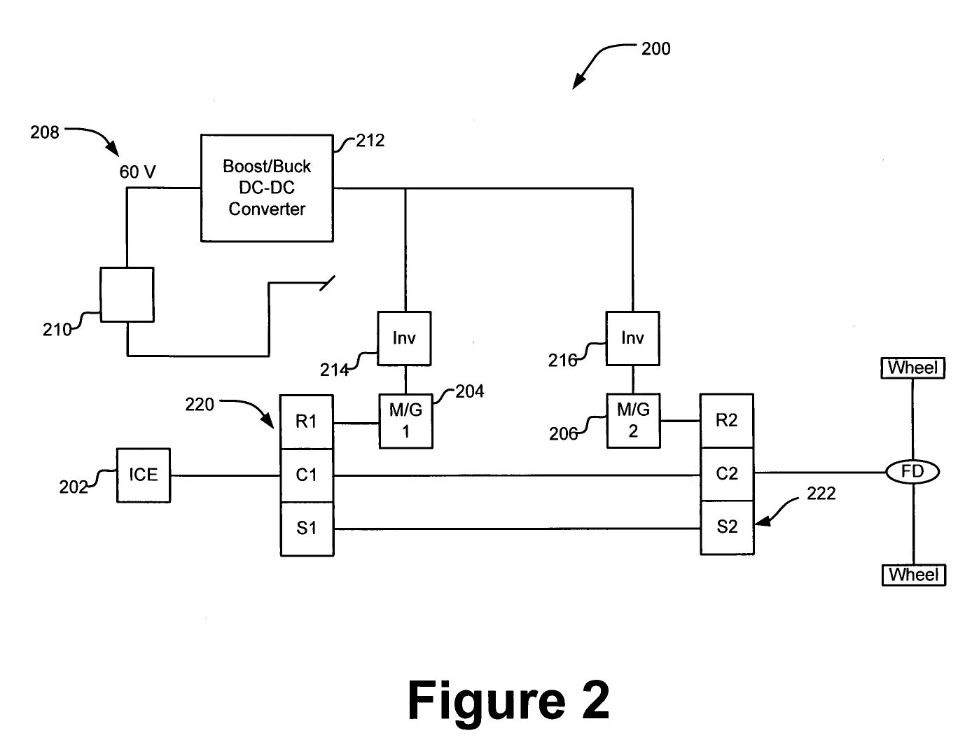

FIG. 2 shows an exemplary compound split electronic continuously variable transmission system 200 for a hybrid vehicle. In the compound split e-CVT, the total propulsion power is the sum of an internal combustion engine 202 and a pair of electric motor/generators 204, 206 powered by a double-layer capacitor power supply 208. The power supply 208 comprises a relatively low voltage double-layer capacitor module 210 (i.e., less than about 140 volts DC), a boost/buck DC-DC converter 212, and a pair of inverters 214, 216. In one implementation, for example, the double-layer capacitor module 210 is rated for no more than about 60 volts DC, no more than about 100 volts DC, or no more than about 140 volts DC.

The pair of motor/generators 204, 206, and the internal combustion engine 202 provide power to drive the wheels of the hybrid vehicle through a pair of planetary gear sets 220, 222. The planetary gear sets 220, 222 act as a speed summing junction that functions as a continuously variable transmission. The planetary gear sets 220, 222 also maintain engine speed variations relatively small. The planetary gear sets 220, 222 each comprise a ring gear R, a planetary carrier C, and a sun gear S. The internal combustion engine is connected to and drives the planetary carrier C₁ of the first planetary gear set 220. The ring gear R₁ of the first planetary gear set 220 is connected to the first motor generator 204. The sun gear S₁ of the first planetary gear set 220 is connected to the sun gear R₂ of the second planetary gear set 222.

The second motor generator 206 is connected to the ring gear R₂ of the second planetary gear set 222. The first motor/generator 204 and the second motor/generator 206 are each coupled to the double-layer capacitor module 210 as shown in FIG. 1. The carrier gear C₂ of the second planetary gear set 222 is connected to a final drive differential gear FD that drives the wheels of the hybrid vehicle.

Although FIGS. 1 and 2 show single mode and compound mode electronic continuously variable transmission systems, other power train systems, such as but not limited to parallel systems (e.g., belt driven, crankshaft mounted, and integrated with a torque converter), series/parallel switching systems (e.g., a single motor system with dual clutches), autonomous or hybridized electronic four wheel drive systems, or other power split configurations could also be used.

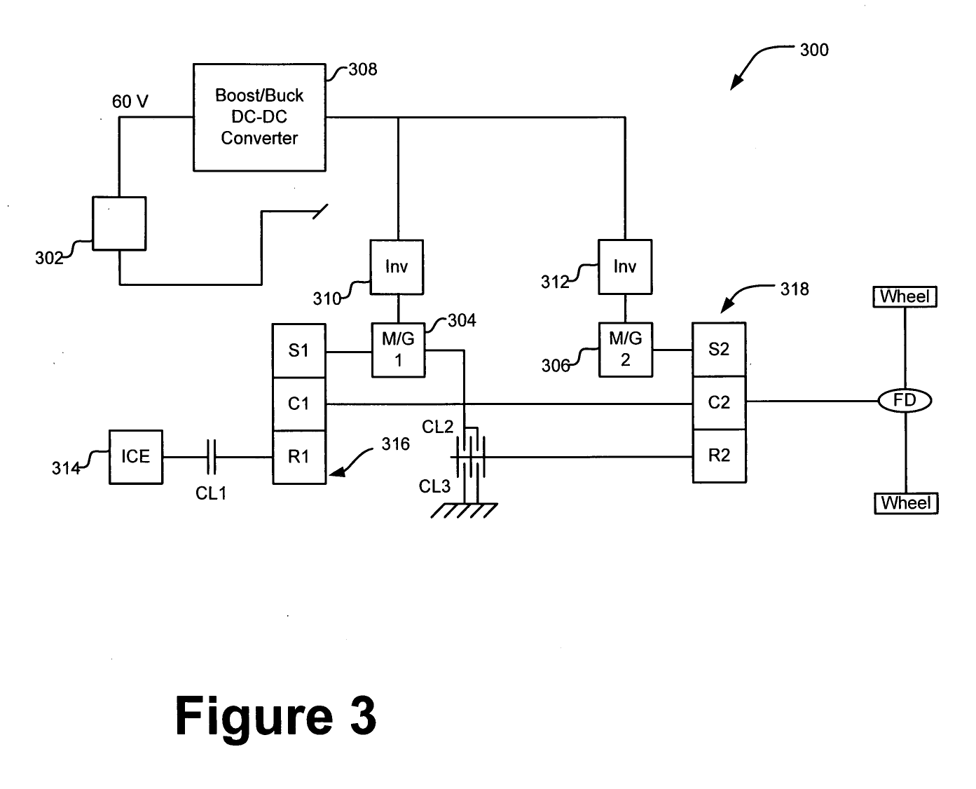

FIG. 3 shows another exemplary configuration of a low voltage double-layer capacitor powered power train system 300 for a hybrid vehicle. The power train system 300 includes a double-layer capacitor module 302 rated for example at about sixty volts DC. The module 302 is coupled to a pair of motor/generators 304, 306 through a boost/buck DC-DC power converter 308 that boosts the voltage of the module 302 from about sixty volts DC to an operating voltage for the motor/generators 304, 306 and a pair of inverters 310, 312 of the power train system 300. The boosted voltage level may be, for example, about 144 volts DC or higher to provide an efficient power train system for a hybrid vehicle. The boosted voltage level provided by the DC-DC power converter 308 is then coupled to the motor/generators 304, 306 via the pair of inverters 310, 312 to convert the DC voltage provided by the DC-DC power converter to AC voltage used for driving the motor/generators of the power train system 300.

In this implementation, an internal combustion engine 314 is connected through a first clutch CL₁ to a ring gear R₁ of a first planetary gear set 316. The first motor/generator 304 is connected between a sun gear S₁ of the first planetary gear set 316 and a ring gear R₂ of a second planetary gear set 318 via a second clutch CL₂. The second clutch CL₂ interfaces with a third clutch CL₃ that is fixed to a transmission case. The second clutch CL₂ and the third clutch CL₃ are operated in a “toggle” configuration (i.e., when the second clutch CL₂ is engaged connecting the ring gear R₂ to the motor/generator 304, the third clutch CL₃ is disengaged and when the second clutch CL₂ is disengaged disconnecting the ring gear R₂ from the motor/generator 304, the third clutch CL₃ is engaged to fix the ring gear R₂ to the transmission case). The planetary carrier gear C1 of the first planetary gear set 316 is coupled to the planetary carrier gear C2 of the second planetary gear set 318 transmitting the power being provided by the internal combustion engine 314 to the second planetary gear set 318. The second motor/generator 306 is connected to a sun gear S2 of the second planetary gear set 318. The planetary carrier gear C₂ of the second planetary gear set 318 is connected to a final drive differential gear FD that drives the wheels of the hybrid vehicle.

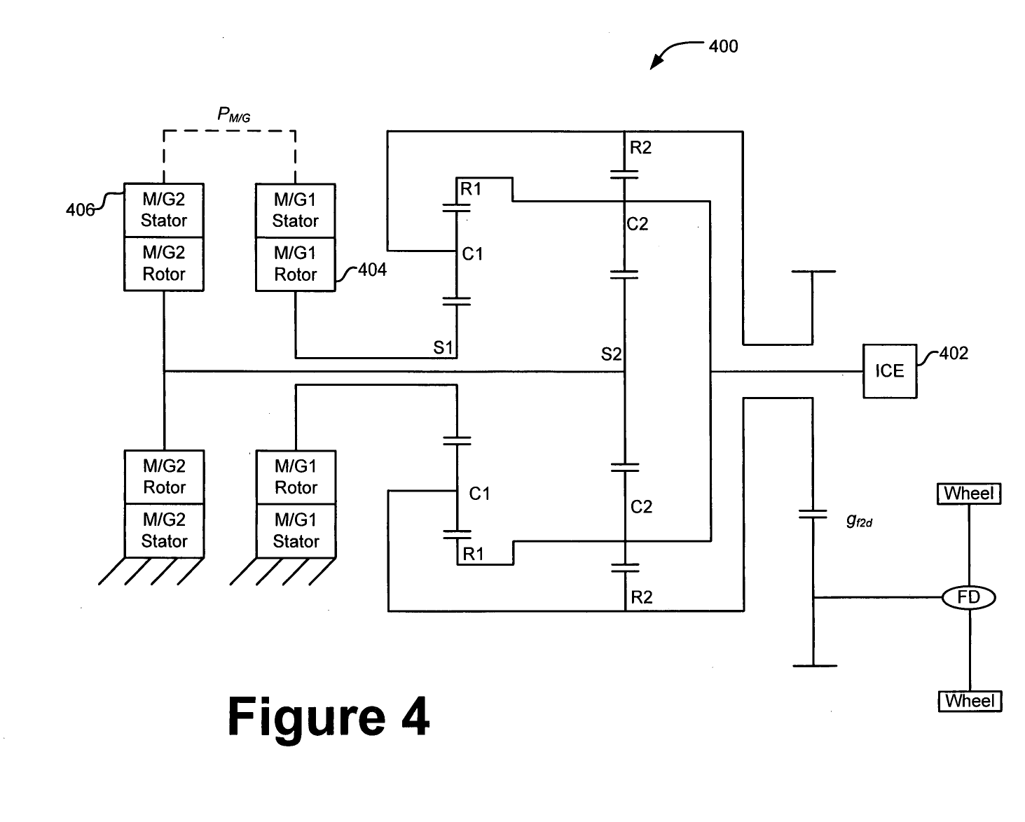

FIG. 4 shows another exemplary configuration of a power train system 400 for a hybrid vehicle. In this implementation, the total propulsion power of the system 400 is the sum of the power supplied by an internal combustion engine 402 and a pair of electric motor/generators 404, 406 powered by a double-layer capacitor power supply. The power supply comprises a relatively low voltage double-layer capacitor module (i.e., less than about 140 volts DC), a boost/buck DC-DC converter, and a pair of inverters as described above with respect to FIGS. 1-3. In one implementation, for example, the double-layer capacitor module is rated for no more than about 60 volts DC, no more than about 100 volts DC, or no more than about 140 volts DC.

The internal combustion engine 402 and the pair of motor/generators 404, 406 provide power to drive the wheels of the hybrid vehicle through a pair of planetary gear sets. The pair of planetary gear sets acts as a speed summing junction that functions as a continuously variable transmission. The planetary gear sets each comprise a ring gear R, a planetary carrier C, and a sun gear S. The internal combustion engine is connected to and drives the planetary carrier C₂ of the second planetary gear set, which is also connected to the ring gear R₁ of the first planetary gear set. A rotor of the first motor generator 404 is connected to and drives the sun gear S₁ of the first planetary gear set. A rotor of the second motor 406 is similarly connected to the sun gear S₂ of the second planetary gear set. Stators of the first motor/generator 404 and the second motor/generator are fixed to a transmission case. The planetary carrier C₁ of the first planetary gear set is connected to the ring gear R₂ of the second planetary gear set.

The first and second motor/generators 404, 406 act in a “toggle” configuration in which when one is operating in a drive mode, the other is not. The motor/generator not operating in a drive mode, for example, may be operating in generator mode to convert kinetic or mechanical energy into electrical power P_{M/G}. The recovered electrical power P_{M/G}, for example, may be provided back to the double-layer capacitor power supply through an inverter connected to the stator of the motor/generator, and/or may be provided to the other motor/generator to power the system 400.

The carrier gear C₁ of the first planetary gear set is connected to gear mesh at g_{f2d}, which in turn is connected to a final drive differential gear FD that drives the wheels of the hybrid vehicle.

Although a buck/boost converter is shown in FIGS. 1-4, other types of boost converters could be used. In one implementation, an exemplary boost/buck DC-DC power converter that may be used to boost the input voltage from a double-layer capacitor module rated at about sixty volts DC to a higher voltage level for use in a power train system of a hybrid vehicle, such as shown in FIGS. 1-4.

A disclosure of one exemplary type of double-layer capacitor that can be used to provide improved characteristics that enable their use at about sixty volts DC and below in a hybrid vehicle is described in copending and commonly assigned U.S. patent application Ser. No. 11/116,882 entitled “Particle packaging systems and methods” and filed by Porter Mitchell et al. on Apr. 27, 2005, which is hereby incorporated by reference in its entirety.

One exemplary type of double-layer capacitor module made of such double-layer capacitors that could be used to provide power to a motor/generator of a hybrid vehicle at a voltage of about sixty volts and below is described in copending and commonly assigned U.S. Pat. No. 7,016,177 entitled “Capacitor heat protection” and filed by Guy C. Thrap on Sep. 3, 2004, which is hereby incorporated by reference in its entirety.

Although embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A hybrid vehicle propulsion system comprising:
a transmission; and
a plurality of double-layer capacitors rated at about sixty volts DC, the capacitors coupled to the transmission to provide power to the transmission.

2. The hybrid propulsion system of claim 1 wherein the transmission is configured in a compound split configuration.

3. The hybrid propulsion system of claim 1 wherein the transmission is configured in a compound split configuration electronic continuously variable transmission system.

4. The hybrid propulsion system of claim 1 wherein the transmission is configured in a single mode configuration.

5. The hybrid propulsion system of claim 1 wherein the transmission is configured in a single mode configuration electronic continuously variable transmission system.

6. The hybrid propulsion system of claim 1 further comprising a DC-DC converter used to raise the voltage of the capacitors to above about sixty volts DC.

7. The hybrid propulsion system of claim 1 wherein a voltage level of the plurality of double-layer capacitors is provided to at least one motor/generator of the transmission via a converter.

8. The hybrid propulsion system of claim 7 wherein the converter comprises a DC-DC converter.

9. The hybrid propulsion system of claim 8 wherein the converter comprises a boost/buck DC-DC converter.

10. The hybrid propulsion system of claim 8 further comprising an inverter disposed between the converter and the motor/generator.

11. The hybrid propulsion system of claim 1 wherein a voltage level of the plurality of double-layer capacitors is raised via a floating bus.

12. A hybrid propulsion system comprising:
an electrical propulsion system; and
a plurality of double-layer capacitors coupled to the electrical propulsion system, the capacitors rated to provide no more than about sixty volts DC.

13. The hybrid propulsion system of claim 12 wherein the plurality of double-layer capacitors are configured in a double-layer capacitor module.

14. A hybrid propulsion system comprising:
an internal combustion engine;
a transmission; and
a plurality of double-layer capacitors coupled to the transmission, the capacitors capable of providing no more than about sixty volts DC.

15. The hybrid propulsion system of claim 14 further comprising a DC-DC converter, the converter coupled between the transmission and the plurality of capacitors.

16. The hybrid propulsion system of claim 15 wherein the DC-DC converter is used to boost the voltage of the capacitors to a level above about sixty volts DC.

17. The hybrid propulsion system of claim 15 wherein the DC-DC converter comprises a boost/buck DC-DC converter.

18. A hybrid propulsion system for a hybrid vehicle, the hybrid propulsion system comprising:
an internal combustion engine;
a transmission rated to operate above a given voltage; and
a plurality of double-layer capacitors rated to provide less than the given voltage.

19. The hybrid propulsion system of claim 18 wherein the given voltage is about sixty volts DC.

20. The hybrid propulsion system of claim 18 wherein the given voltage is about 100 volts DC.

21. The hybrid propulsion system of claim 18 wherein the given voltage is about 144 volts DC.
